(19) United States
(12) Patent Application Publication
(10) Pub. No.: US 2015/0370899 A1
(43) Pub. Date: Dec. 24, 2015

(54) SHORTENED URL MANAGEMENT METHOD AND MANAGEMENT DEVICE, AND STORAGE MEDIUM STORING COMPUTER PROGRAM FOR MANAGEMENT THEREOF

(71) Applicant: Yang Won JUNG, (US)

(72) Inventor: Yang Won JUNG, Seoul (KR)

(73) Assignee: WILUS INSTITUTE OF STANDARDS AND TECHNOLOGY INC., Seoul (KR)

(21) Appl. No.: 14/761,947

(22) PCT Filed: Dec. 19, 2013
(86) PCT No.: PCT/KR2013/011865

§ 371 Date: Jul. 20, 2015

(30) Foreign Application Priority Data
Jan. 18, 2013 (KR) 10-2013-0005950

(51) Int. Cl. G06F 17/30; H04L 29/08

(52) U.S. Cl. CPC G06F 17/30864; G06F 17/30887; G06F 17/30899; H04L 67/02

(57) ABSTRACT

A method which is performed in a communication apparatus, including: receiving a shortened URL from a server through a network; comparing the shortened URL with at least one URL in a URL database to obtain a first result value; receiving an actual URL corresponding to the shortened URL from a shortened URL providing server through the network; and comparing the actual URL with at least one URL in the URL database to obtain a second result value.

### TECHNICAL FIELD

The present invention relates to a uniform resource locator (URL) which indicates an address of a specific resource, such as a web page, on the Internet, and specifically, relates to a URL shortening technique which converts a long URL into a shortened URL having a short length and retransmits a web page having the original long URL when a user tries to access through the converted shortened URL. More specifically, the specification relates to a method of managing a shortened URL in a communication apparatus of a user.

### BACKGROUND ART

Generally, a URL which indicates an address of a specific web page is configured by combination of a series of alphabets, numbers, and several special symbols which descriptively describe various information (for example, a page hierarchy, an instruction structure, a channel of communication, or session information) on the web page. Therefore, in some cases, a length of the URL may be significantly long. For example, a URL indicating a web page of a “Route Map” of a homepage of Korean Intellectual Property Office (KIPO) is represented to be long and complex as indicated in Reference Item 1.

[Reference Item 1]

http://www.kipo.go.kr/kpo/user.tdf?a=user.html.HtmlApp&c=6017&catmenu=m05_{—}06_{—}01

However, it is difficult for the long URL as indicated above to be used when there is a limitation in the number of characters of a message to be transmitted, for example, an SMS of a cellular phone or an SNS of Twitter. One method of solving the above problem is utilizing a URL shortening service. According to the URL shortening service, a service provider converts a long URL into a shortened URL having a short length and also still permits access to a web page which is intended by the original long URL, so that it is convenient for the user to use an SMS or SNS. There is a lot of URL shortening service providers, such as Google (http://goo.gl), Naver (http://me2.do), bitly (https://bitly.com).

As described above, there is a plurality of URL shortening service providers, such that a plurality of different shortened URLs may be created by individual URL shortening services with respect to the same original URL. For example, when the original URL of Reference Item 1 is shortened using the service (http://goo.gl) for Google, the shortened URL is “http://goo.gl/0fr0U” and when the original URL is shortened by the Naver service (http://me2.do), the shortened URL is “http://me2.do/5Fzl00Z”. However, when a user B sends “http://goo.gl/0fr0U” to a user A and another user C sends “http://me2.do/5Fzl00Z” to the user A, both shortened URLs are different. Therefore, the user A does not recognize from the URL that the shortened URL sent from the user B and the shortened URL sent from the user C actually indicate the same URL.

Whether to access a URL or a link thereof which is displayed on a web page in the past is generally represented by a color and when a URL or a link thereof which has not been accessed is represented with a blue color and a URL or a link thereof which has been accessed is displayed with a purple color. In other words, a browser which displays the web page memorizes the URL of the web page which has been accessed and represents the past access by a color for the user, so that the user distinguishes the web page which has been accessed. In the above example, when the user A accesses the web page (“Route Map” of the KIPO homepage which is a web page corresponding to the actual URL of Reference Item 1) through the shortened URL of the user B and then accesses through the shortened URL of the user C, the shortened URL of the user C is not represented by the color (the purple in the above example) which represents the past access so that the user A does not recognize that the user A has accessed the web page indicated by the shortened URL of the user C.

### DISCLOSURE

### Technical Problem

An exemplary embodiment of the present invention provides a method that distinguishes a plurality of shortened URLs indicating one actual URL in a terminal of a user to distinguish whether to access web pages of actual URLs for different shortened URLs in the past and notify whether to access the web page of the actual URL with respect to different URLs in the past to the user, a device of implementing the method, or a recording medium which stores a computer program which executes the method.

An exemplary embodiment of the present invention provides a method which, when any one shortened URL is received on a terminal of a user, distinguishes whether the shortened URL is a link which has been accessed in the past by comparing/determining not only a shortened URL but also an actual URL of the shortened URL and notifies a distinguishing result to the user, a device of implementing the method, or a recording medium which stores a computer program which executes the method.

### Technical Solution

As a technical means for solving the above-described technical problems, a first aspect of the present invention provides a method which is performed in a communication apparatus, including: receiving a shortened URL from a server through a network; comparing the shortened URL with at least one URL in a URL database to obtain a first result value; receiving an actual URL corresponding to the shortened URL from a shortened URL providing server through the network; and comparing the actual URL with at least one URL in the URL database to obtain a second result value.

A second aspect of the present invention provides a shortened URL managing device which is used in a communication apparatus including: a shortened URL receiving module which receives a shortened URL from a server through a network; an actual URL receiving module which receives an actual URL corresponding to the shortened URL from a shortened URL providing server through the network; and a URL comparing module which compares the actual URL with at least one URL in a URL database.

A third aspect of the present invention provides a recording medium in which a computer program which is executed on a processor of electronic equipment having a communication function is recorded, the computer program causing the processor to perform: receiving a shortened URL from a server through a network; comparing the shortened URL with at least one URL in a URL database to obtain a first result value; requesting an actual URL corresponding to the shortened URL to a shortened URL providing server through the network; receiving an actual URL corresponding to the shortened URL from the shortened URL providing server through the network; and comparing the actual URL with at least one URL in the URL database to obtain a second result value.

### Advantageous Effects

According to any one of the solving means of the present invention described above, when there is a plurality of shortened URLs which indicates one actual URL, if a user accesses the web page through any one shortened URL and then accesses the same web page through a different shortened URL, it is possible to distinguish and notify whether to access the URL in the past to the user in spite of the different URLs. Therefore, the user may avoid a redundant access and a redundant transmission of the same data is suppressed from a viewpoint of network traffic, so that convenience for the user is generally increased and network traffic is reduced.

The above effect is just an example and all advantageous effects which may be recognized by those skilled in the art based on the solving means of the problem and the detailed description of the invention and claims described with reference to the accompanying drawings may be intended by disclosure of the specification.

### DESCRIPTION OF DRAWINGS

FIG. 1 is a diagram of a network system illustrating a configuration of a general server and a client terminal.

FIG. 2 is a view illustrating a screen which displays a short URL for a long URL through an URL shortener provided by Google, as an example of a shortened URL providing service.

FIG. 3 is a view illustrating correspondence of a shortened URL which is converted from a long URL through a URL shortener of FIG. 2.

FIG. 4A is a diagram of a network system according to an exemplary embodiment of the present invention.

FIG. 4B is a diagram of a network system according to another exemplary embodiment of the present invention.

FIG. 5 is a view illustrating a configuration of an URL database according to an exemplary embodiment of the present invention.

FIG. 6 is a view illustrating a configuration of a URL database according to another exemplary embodiment of the present invention.

FIG. 7 is a view illustrating a configuration of a URL database according to another exemplary embodiment of the present invention.

FIG. 8 is a block diagram illustrating a shortened URL managing device according to an exemplary embodiment of the present invention.

FIG. 9 is a flow chart illustrating a shortened URL managing method according to an exemplary embodiment of the present invention.

### BEST MODE

Hereinafter, exemplary embodiments of the present invention will be described more fully hereinafter with reference to the accompanying drawings, so as to be easily carried out by those skilled in the art. However, the present invention can be realized in various different forms, and is not limited to the exemplary embodiments described herein. Accordingly, In order to apparently describe the present invention, a portion that does not relate to the description is omitted. Like reference numerals designate like elements throughout the specification.

Throughout this specification, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements. Exemplary embodiments described in the detailed description, the drawings, and the claims are not interpreted to limit the present invention and another exemplary embodiment or modification may be allowed without departing from the scope and the spirit of the object suggested here. It may be easily understood that aspects of the present invention as generally described here and illustrated in the drawings may be arranged, replaced, combined, and designed by various different configurations and these are clearly considered and become a part of the disclosure.

The present invention specifically relates to a method, a system, and a computer program which manage a shortened URL and an actual URL together to distinguish and/or recognize a browsing history of the link to efficiently manage the shortened URL and notify the browsing history to a user. Hereinafter, the present invention will be described in detail with reference to the accompanying drawings.

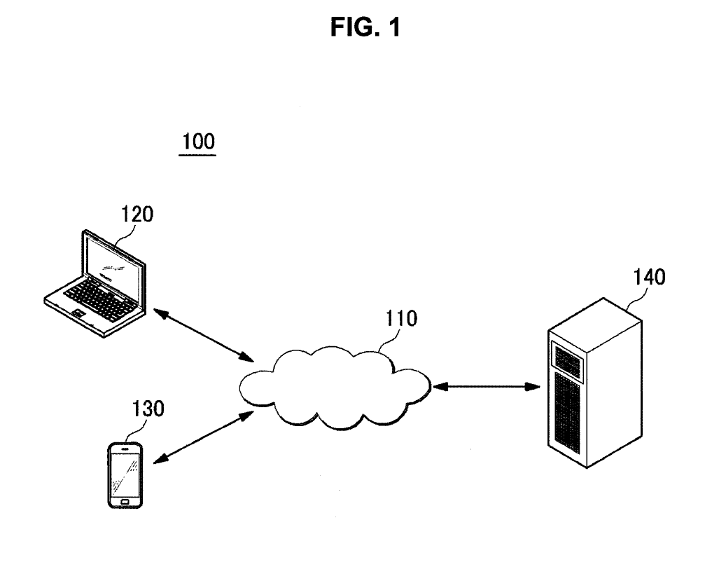

FIG. 1 is a diagram of a network system illustrating a configuration of a general server and a client terminal. An exemplary network system 100 illustrated in FIG. 1 is configured by user terminals 120 and 130, and a server 140 which are connected through a network 110. The network 110 may be an internet network and includes a wired network and a wireless network. The user terminals 120 and 130 may be a non-mobile terminal such as a desktop computer or a mobile terminal such as a laptop computer or a mobile terminal. The user terminals 120 and 130 may have a general wired or wireless communication function and may perform data communication with the server 140 and/or other user terminals through the networks 110. The server 140 transmits and receives data to and from the user terminals 120 and 130 and the data may include not only a general web page, but also data which is transmitted from the third party such as an email message or an SNS message. In other words, the server 140 may include a web server, a mail server, an SNS server, and a data server and a plurality of users may access the server 140 without being bound by the time and a location, like a cloud data center.

The user terminals 120 and 130 may include a program or an application which executes data transmitted from the server 140. For example, when a web page is transmitted from the server 140, a browser which executes the web page is required, when an email is transmitted from the server, a mail program which may read the email is required, and when an SNS message is transmitted from the server 140, an SNS application which reads the message is required.

Data which is transmitted from the server 140 to the user terminals 120 and 130 through the network 110 may include an URL of a specific link. The user terminals 120 and 130 may access a server (not illustrated) of the specific link through the network 110 using the URL to receive the data. Here, the URL may indicate a web page stored in a server of the specific link and the URL may be an actual URL which directly indicates the web page or a shortened URL which is shortened by a URL shortening service.

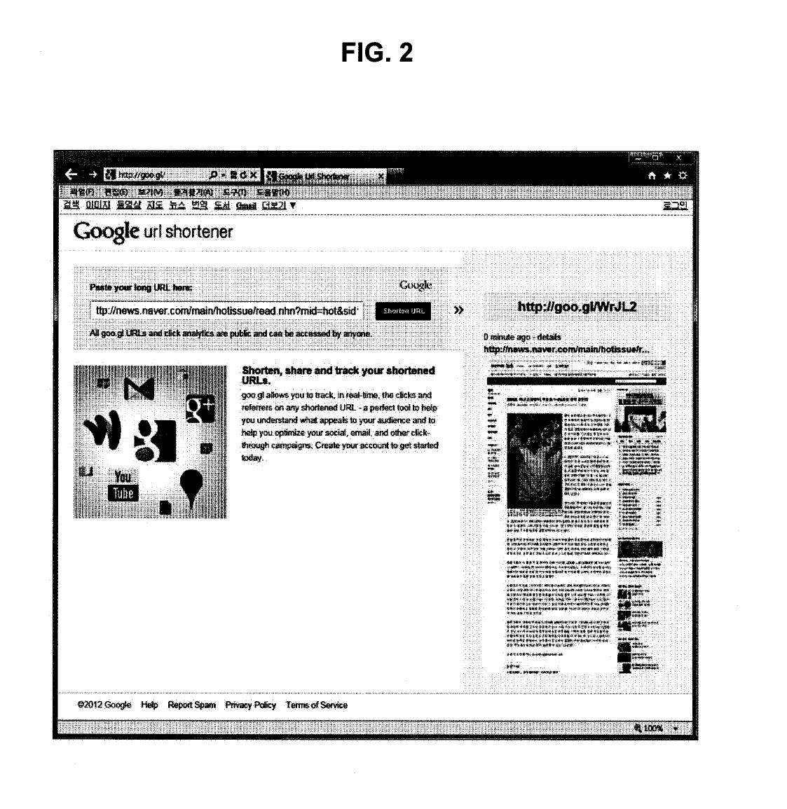

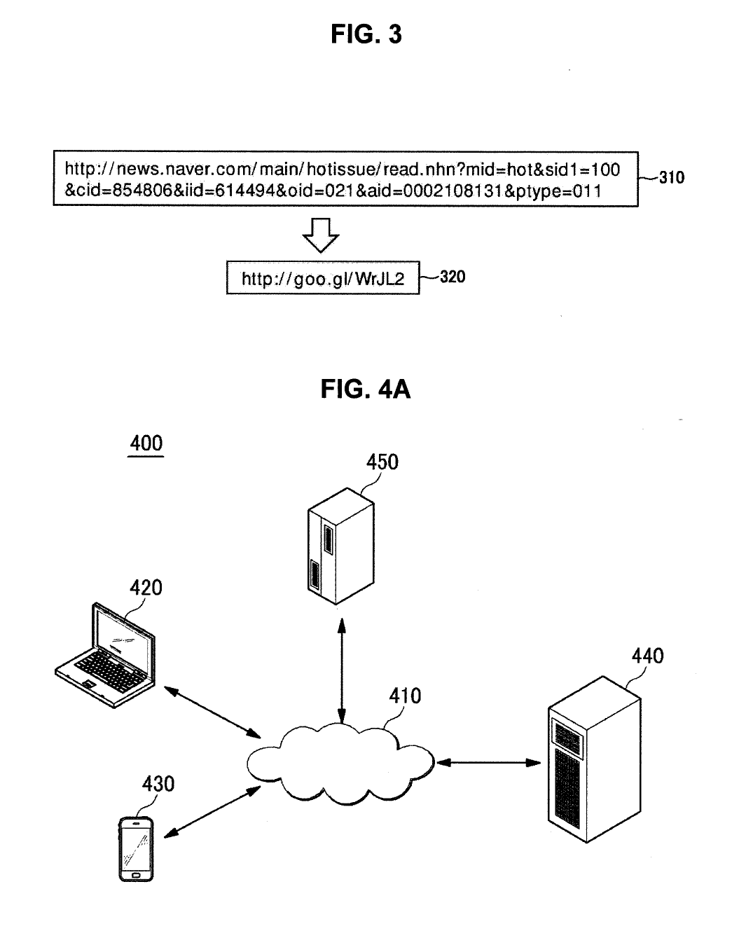

FIG. 2 is a view illustrating a screen which displays a short URL by converting a long URL into the short URL through an URL shortener provided by Google, as an example of a shortened URL providing service. FIG. 3 is a view illustrating correspondence of a shortened URL which is converted from a long URL through a URL shortener of FIG. 2. FIGS. 2 and 3 illustrate an example of a general service which is used to shorten an URL but the present invention is not limited or restricted thereto.

An actual URL having a long length is converted into a shortened type through a service (http://goo.gl) which is provided by Google. An actual URL (310) may be simply converted into a shortened URL, denoted by reference numeral 320 of FIG. 3 and displayed at a right side of the screen of FIG. 2, by entering an actual URL denoted by reference numeral 310 in FIG. 3 to an actual URL input section of FIG. 2 and clicking a “shorten URL” button. A plurality of service providers provides the shortened URL and most of them provide a service which converts an actual URL having a long length into a shortened URL using the similar method thereto.

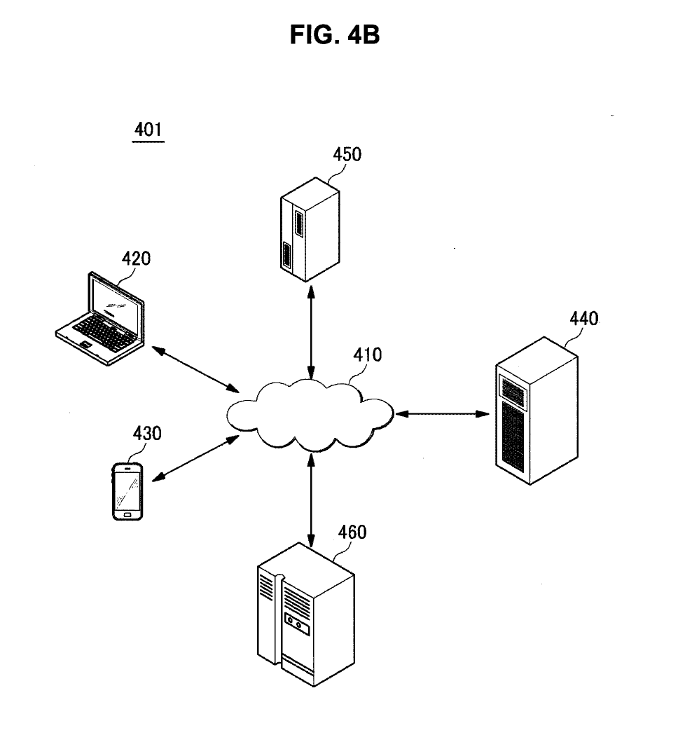

FIG. 4A is a diagram of a network system according to an exemplary embodiment of the present invention. As illustrated in FIG. 4, a network system 400 according to an exemplary embodiment of the present invention includes a network 410 and user terminals 420 and 430, a server 440, and a shortened URL providing server 450 which are connected to the network. The network 410, the user terminals 420 and 430, and the server 440 correspond to the network 110, the user terminals 120 and 130, and the server 140 of FIG. 1 or have the similar functions thereto. Therefore, specific description thoseof will be omitted for the purpose of simplicity.

The shortened URL providing server 450 performs a shortened URL providing service which has been described above with reference to FIGS. 2 and 3 and stores the shortened URL as a result of the service in a shortened URL providing server 450 or an external storage device by matching the shortened URL and the actual URL. Therefore, when the user terminal requests transmission of an actual URL for the shortened URL, the shortened URL providing server 450 may transmit the actual URL to the user terminal. Further, when the shortened URL providing server 450 receives a retransmission request of a link based on the shortened URL which is provided by the shortened URL providing server 450 from the user terminal, the shortened URL providing server 450 serves to retransmit the link corresponding to the actual URL to the user terminal which requests the retransmission of the link, in accordance with the request.

Hereinafter, an exemplary embodiment of the present invention will be described in detail as one scenario by limiting a function of each component according to an exemplary embodiment of the present invention but the following description will not affect the scope of the present invention which is understood from the components or the entire disclosure. As a non-restrictive example, when the user terminal 420 tries to provide an URL (for example, denoted by reference numeral 310 of FIG. 3) having a long length to the user terminal 430 through the server 440 which provides the SNS service , the URL having a long length cannot be transmitted due to data limitation of the SNS service. In this case, the user terminal 420 may access the shortened URL providing server 450 through the network 410 to convert the URL having a long length into a shortened short URL (for example, denoted by reference numeral 320 of FIG. 3). The user terminal 420 executes an SNS application of the user terminal 420 to transmit the shortened URL to the server 440 through the network 410, so that the user terminal 430 may receive the shortened URL from the server 440.

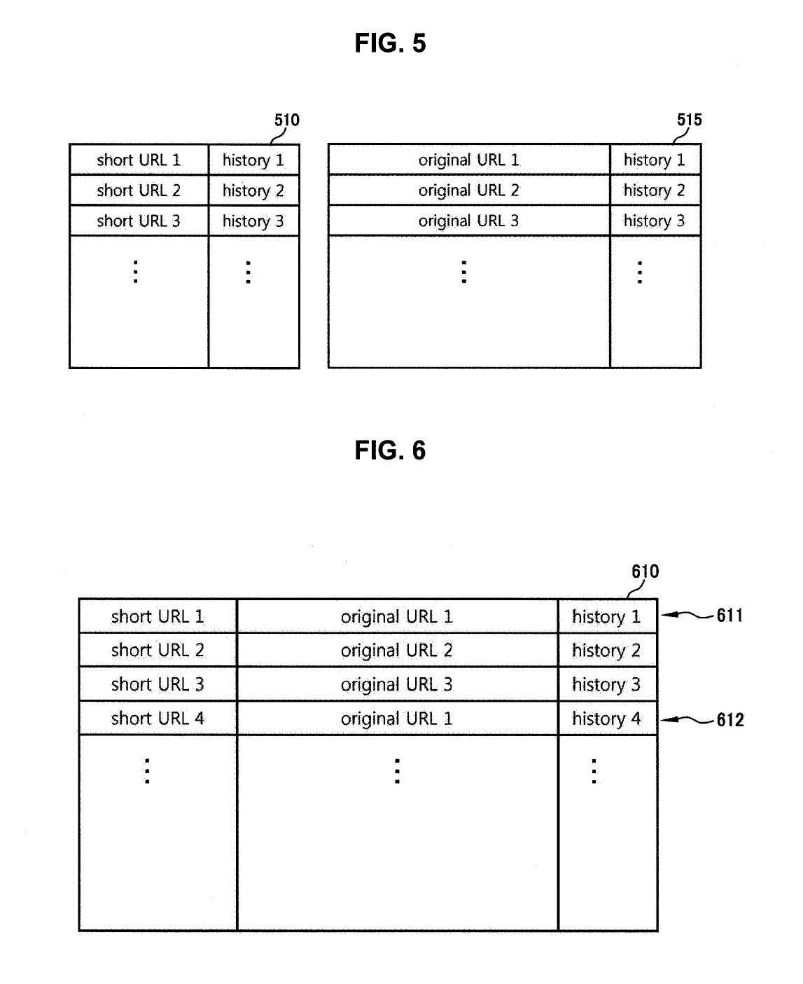

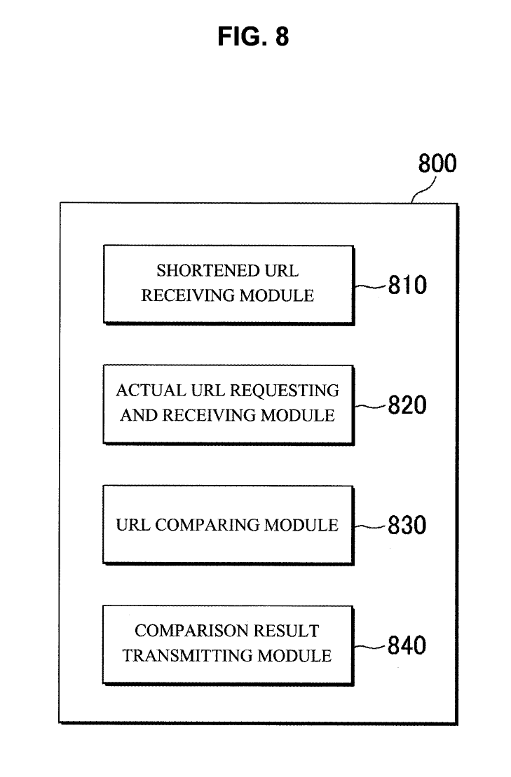

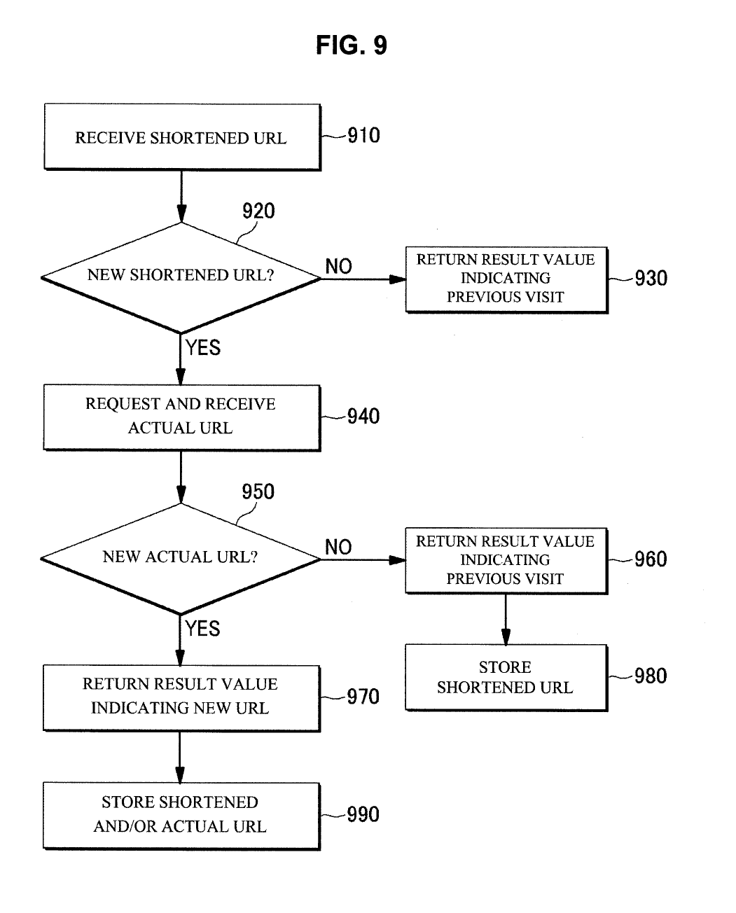

The user terminal 430 may access the server 440 through the network 410 to receive the shortened URL transmitted from the user terminal 420. Here, the user terminal 430 may include a URL database and the URL database includes URLs of links which are accessed by the user of the user terminal 430 and a history of the accessed URLs, that is, a browsing history. The URLs included in the URL database include shortened URLs and actual URLs. A shortened URL is implemented as a shorten URL list with the browsing history and an actual URL is implemented as an actual URL list with the same. Otherwise a shortened URL and an actual URL corresponding thereto match each other to be implemented as one list with the browsing history. Furthermore a shortened URL and an actual URL are implemented as one list with each browsing histories without distinguishing the shortened URL and the actual URL. The URL database will be described in more detail below with reference to FIGS. 5 to 7. Further, the shortened URL which is received by the user terminal 430 is processed by referring to the URL database, which will be described in detail with reference to FIGS. 8 and 9.

FIG. 4B is a diagram of a network system according to another exemplary embodiment of the present invention. A network system 401 of FIG. 4B includes an URL database server 460 which stores the URL database in addition to the network 410, the user terminal 420 and 430, the server 440, and the shortened URL providing server 450 connected thereto of FIG. 4A. In the system 400 of FIG. 4A, even though it is described that the list (a shortened URL list and an actual URL list) of URLs of the links which are accessed by the users of the user terminals 420 and 430 and the URL database including the history are included on the terminal (for example, stored in a storage device in each terminal), in the system 401 of FIG. 4B, the URL database is stored in a separate URL database server 460. The URL database server 460 may be a cloud data center and when a user uses a plurality of terminals, and may collectively manage a browsing history of the user and URLs in the unit of a user. As an example which does not limit the technical spirit of the present invention, when the same user uses both the user terminal 420 and the user terminal 430, the URLs (the shortened URL and the actual URL) of the link which is accessed through the user terminal 420 by the user and the histories are stored in the URL database of the URL database server 460. When the user tries to access the link of the specific URL through the user terminal 430 thereafter, whether the user accessed the link may be distinguished by referring to the URL database of the URL database server 460.

FIG. 5 is a view illustrating a configuration of an URL database according to an exemplary embodiment of the present invention. As illustrated in FIG. 5, the URL database includes a shortened URL list 510 and an actual URL list 515. The shortened URL list 510 includes shortened URLs (short URL 1, short 2, and short URL 3) of the shortened URLs of the links which were accessed by the user and history information (history 1, history 2, and history 3) on the shortened URLs. Further, the actual URL list 515 includes actual URLs (original URL 1, original URL 2, and original URL 3) of the links which were accessed by the user and history information (history 1, history 2, and history 3) on the actual URLs. The history information includes information on a time when the user accesses the link, device information on a user terminal which is used as a medium when the user accesses the link, and information on the link, but is not limited thereto.

The URL database illustrated in FIG. 5 is provided for every user and when a URL (a shortened URL or an actual URL) is suggested to the user or the user tries to access the URL, the URL is compared with the URLs in the shortened URL list 510 and the actual URL list 515 in parallel. Here, the actual URL list 515 may include the actual URL of the shortened URL which is included in the shortened URL in the shortened URL list 510. For example, when the user terminal 430 receives a new shortened URL which is not included in the shortened URL list 510, the shortened URL is stored in the shortened URL list 510 together with the history thereof and the user terminal 430 requests and receives the actual URL from the shortened URL providing server 450 and then stores the actual URL in the actual URL list 515. A series of specific processings will be described below.

FIG. 6 is a view illustrating a configuration of a URL database according to another exemplary embodiment of the present invention. As illustrated in FIG. 6, in the URL database 610, a shortened URL, an actual URL corresponding thereto, and a browsing history of the user to the link are stored as one set. For example, in a set denoted by reference numeral 611, a shortened URL (short URL 1), an actual URL thereof (original URL 1), and history information (history 1) of user's access to the link are stored together. In the meantime, in a set denoted by reference numeral 612, a different shortened URL (short URL 4) matches the actual URL (original URL 1) which is the same as that in the set denoted by reference numeral 611. This is because a plurality of shortened URLs may be provided for the same actual URL, as described above. The set denoted by reference numeral 611 and the set denoted by reference numeral 612 indicate that the user accesses the link corresponding to the same actual URL through different shortened URLs and history information is separately stored as history 1 and history 4. The history information includes information on a time when the user accesses the link, device information on a terminal which is used as a medium when the user accesses the link, and information on the link, but is not limited thereto.

The URL database 610 illustrated in FIG. 6 is provided for every user and when an URL (a shortened URL or an actual URL) is suggested to the user or the user tries to access the URL, the URL is compared with the shortened URL and the actual URLs in the URL database 610. For example, when a URL which is suggested to the user is a shortened URL, it is checked whether the shortened URL is present in the URL database 610 and when the shortened URL is present in the URL database 610, it is displayed to the user that the shortened URL has been accessed in the past. A series of specific processings will be described below.

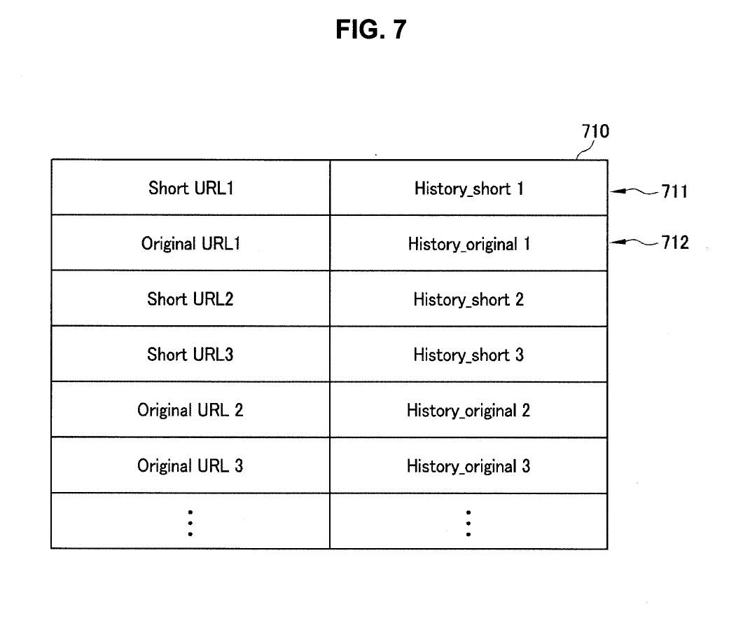

FIG. 7 is a view illustrating a configuration of a URL database according to another exemplary embodiment of the present invention. As illustrated in FIG. 7, the URL database 710 collectively stores the shortened URLs (short URL 1, short URL 2, and short URL 3) and the actual URLs (original URL 1, original URL 2, and original URL 3), history information on the shortened and actual URLs (history short 1, history short 2, history short 3, history original 1, history original 2, and history original 3) without having any differentiation in the combined URL list. For example, in a row denoted by reference numeral 711, a shortened URL, short URL 1, and the history information, History_short 1, corresponding thereto are stored and in a row denoted by reference numeral 712, an actual URL, original URL 1, and the history information, History_original 1, corresponding thereto are stored. The history information includes information on a time when the user accesses the link, device information on a user terminal which is used as a medium when the user accesses the link, and information on the link, but is not limited thereto.

The URL database 710 illustrated in FIG. 7 is provided for every user and when a URL (a shortened URL or an actual URL) is suggested to the user or the user tries to access the URL, the URL is compared with the URLs in the combined URL list. Here, the combined URL list may include the corresponding actual URL of the shortened URL. For example, when the user terminal 430 receives a new shortened URL which is not included in the combined URL list, the shortened URL is stored in the combined URL list together with the history thereof and the user terminal 430 requests and receives the actual URL from the shortened URL providing server 450 and then stores the actual URL in the combined URL list 515. The series of specific processings will be described below.

The URL database suggested in FIGS. 5 to 7 are just examples and various methods which match the shorted URL, the actual URL, and the information on the browsing history of the user to the link corresponding to the URL to configure a database may be allowed without departing from the technical spirit of the present invention. Further, the URL database may be stored in the user terminal as described with reference to FIG. 4 or stored in a separate server to separately manage the browsing history of the user in the unit of the user.

FIG. 8 is a block diagram illustrating a shortened URL managing device according to an exemplary embodiment of the present invention. As illustrated in FIG. 8, a shortened URL managing device 800 includes a shortened URL receiving module 810, an actual URL requesting and receiving module 820, a URL comparing module 830, and a comparison result transmitting module 840. Even though modules are illustrated as individual separate modules in FIG. 8, but the modules may divided into sub-modules in accordance with a function or two or more modules may be combined into one module, or some module may be removed, within the scope of the present invention. Further, those skilled in the art may understand that each function and/or operation is individually and/or two or more functions and/or operations may be combined to be implemented by various types of hardware, software, firmware, or a virtual combination thereof.

In some non-restrictive embodiments of the present invention, the shortened URL managing device 800 is mounted in the user terminals 420 and 430 of FIG. 4A or 4B to manage the shortened URL of the terminal. Hereinafter, for the convenience of description, the function will be described under the assumption that the shortened URL managing device 800 is mounted in the user terminal 430 of FIG. 4A, and will be described under the assumption that the URL database of FIG. 5 is stored in the storage device of the user terminal 430.

The shortened URL receiving module 810 receives a shortened URL or a page including the shortened URL from the server 440 through the network 410. For example, the shortened URL may be transmitted from the user of the user terminal 420 to the user of the user terminal 430 and the user of the user terminal 420 may shorten the actual URL through the shortened URL providing server 450 prior to transmission. Here, the shortened URL providing server 450 converts the actual URL into a shortened URL, and matches and stores the shortened URL and the actual URL to retransmit the actual URL corresponding to a shortened URL when the users access the shortened URL thereafter.

The actual URL requesting and receiving module 820 requests an actual URL corresponding to the received shortened URL to the shortened URL providing server 450 and receives an actual URL as a result of the request. The received actual URL is checked by the URL comparing module 830 together with the shortened URL.

When the URL database is configured as illustrated in FIG. 5, the URL comparing module 830 compares the received shortened URL with each shortened URL in the list in order to check whether the received shortened URL is included in the shortened URL list 510 of the URL database. When the received shortened URL is already included in the shortened URL list 510, the received shortened URL means that the user accessed the URL in the past. When the received shortened URL is already included in the shortened URL list 510, the actual URL requesting and receiving module 820 may not perform the above-described function.

The URL comparing module 830 further compares the actual URL received from the shortened URL providing server 450 with the actual URL list 515 in order to check whether the actual URL is included in the actual URL list 515 of the URL database. A task of comparing the shortened URL and the actual URL with the URL database may be performed in parallel or an actual URL comparing task may be sequentially performed after performing the shortened URL comparing task. The latter is a non-restrictive embodiment and only when the shortened URL is not included in the shortened URL list 510 after performing the shortened URL comparing task, the URL requesting and receiving module receives the actual URL corresponding to the shortened URL and the actual URL comparing task may be performed.

When a received shortened URL is included in the shortened URL list 510, as a result of comparing the received shortened URL with the shortened URL list 510 in the URL database by the URL comparing module 830, the comparison result transmitting module 840 outputs a result value indicating that the user of the user terminal 430 has accessed the web page of the shortened URL. Further, when a received actual URL is included in the actual URL list 515, as a result of comparing the received actual URL with the actual URL list 515 in the URL database by the URL comparing module 830, the comparison result transmitting module 840 outputs a result value indicating that the user of the user terminal 430 has accessed the corresponding web page of the actual URL. When the shortened URL received by the URL comparing module 830 and the actual URL corresponding thereto are not included in the URL database, the comparison result transmitting module 840 outputs a result value indicating that the user has not accessed the web page to the user. The result values (the result value indicating that the user has accessed the web pages and the result value indicating that the user has not accessed the web pages) may be implemented on the display of the user terminal 430 by a color. According to a generally used method, when there is a browsing history, the link is represented with a blue color and when there is no browsing history, the link is represented with a purple color, but is not limited thereto and may be implemented by various methods to be recognized by the user.

As a non-restrictive example of implementing the result value according to the present invention with a color, when the received shortened URL is not included in the shortened URL list in the URL database but the received actual URL is included in the actual URL list in the URL database, the received shortened URL is represented with the purple color.

In the meantime, when the URL database is configured as illustrated in FIG. 7, the URL comparing module 830 compares the received shortened URL with each URL in the list in order to check whether the received shortened URL is included in the combined URL list of the URL database. When the received shortened URL is already included in the combined URL list, the received shortened URL means that the user has accessed the URL in the past. When the received shortened URL is already included in the combined URL list, the actual URL requesting and receiving module 820 may not perform the above-described function.

The URL comparing module 830 compares the actual URL received from the shortened URL providing server 450 with URL in the list in order to check whether the actual URL is included in the combined URL list of the URL database. In this case, only when the shortened URL is not included in the combined URL list 510 after performing the shortened URL comparing task, the actual URL request and receiving module receives the actual URL corresponding to the shortened URL and the actual URL comparing task may be performed.

When a received shortened URL is included in the combined URL list, as a result of comparing the received shortened URL with the combined URL list in the URL database by the URL comparing module 830, the comparison result transmitting module 840 outputs a result value indicating that the user of the user terminal 430 has accessed the web page of the shortened URL. When a received actual URL is included in the combined URL list, as a result of comparing the received actual URL with the combined URL list in the URL database by the URL comparing module 830, the comparison result transmitting module 840 outputs a result value indicating that the user of the user terminal 430 has accessed the web page of the actual URL. When the shortened URL received by the URL comparing module 830 and the actual URL corresponding thereto are not included in the URL database, the comparison result transmitting module 840 outputs a result value indicating that the user has not accessed the web page to the user. The result value (a result value indicating that the user has accessed the web pages and a result value indicating that the user has not accessed the web pages) is implemented on the display of the user terminal 430 with a color. According to a generally used method, when there is a browsing history in the past, the link is represented with a blue color and when there is no browsing history in the past, the link is represented with a purple color, but is not limited thereto and the result value may be implemented by various methods to be recognized by the user. Further, as an example of implementing the result value with a color, the received shortened URL is not included in the combined URL list in the URL database but the received actual URL is included in the combined URL list in the URL database, the received shortened URL is represented with a purple color.

FIG. 9 is a flow chart illustrating a shortened URL managing method according to an exemplary embodiment of the present invention. A process of FIG. 9 may be implemented by using the network system 400 of FIG. 4A, or the network system 401 of FIG. 4B, and/or the shortened URL managing device 800 of FIG. 8 which have been discussed above. An exemplary process may include one or more operations, actions, or functions described in each block by one or more of blocks 910, 920, 930, 940, 950, 960, 970, 980 and/or 990 of FIG. 9. Further, even though in FIG. 9, individual blocks are illustrated, the block may be divided into sub blocks or several blocks are combined to be one block, or some blocks may be removed depending on various requests. In the following description, as a simple example for the convenience of description, it is described that the operation, the action, or the function of each block is implemented in the shortened URL managing device 800 of FIG. 8, the shortened URL managing device 800 is mounted in the user terminal 430 of FIG. 4A, and the URL database of FIG. 5 is stored in the storage device of the user terminal 430, but the present invention is not limited to the illustrative description.

In block 910, the shortened URL managing device 800 of the user terminal 430 receives a shortened URL or data including the shortened URL from the server 440. The shortened URL may be obtained by shortening the actual URL which may be transmitted from the user terminal 420 to the user terminal 430 through the server 440 using the shortened URL providing server 450. The server 440 may be an SNS providing server, and in a state in which the user terminal 420 transmits a message or a page including the shortened URL to the server 440 using an application of the SNS service, the shortened URL managing device 800 of the user terminal 430 receives the message or the page including the shortened URL from the server 440.

In block 920, the shortened URL managing device 800 of the user terminal 430 determines whether the received shortened URL is a link which has been accessed in the past or a new link. The determination may be performed by comparing the received shortened URL with the URL of the URL database stored in the storage device of the user terminal 430. The process goes to block 930 or block 940 according to the determination result that the received shortened URL is a new URL or a URL which has been accessed in the past.

When the received shortened URL has been accessed in the past as a result of determination, in block 930, the shortened URL managing device 800 of the user terminal 430 transmits the result to a processor (not illustrated) of the user terminal 430 to perform a succeeding task of notifying the user. For example, the succeeding task includes a task of displaying the color indicating that the received shortened URL has been accessed in the past on a display of the user terminal 430.

When the received shortened URL is a new URL as a result of determination result of block 920, for example, when the received shortened URL is not included in the URL database stored in the storage device of the user terminal 430, in block 840, the user terminal 430 requests and receives the actual URL of the received shortened URL. For example, the user terminal 430 requests the actual URL to the shortened URL providing server 450 through the network 410 and receives the actual URL therefrom.

In block 950, the shortened URL managing device 800 of the user terminal 430 determines whether the received actual URL is a link which has been accessed in the past or a new link. As a non-restrictive embodiment, the shortened URL managing device 800 compares the received actual URL with the actual URL of the URL database stored in the storage device of the user terminal 430 and determines whether the received actual URL is a new URL. The process goes to block 960 or block 970 according to the determination result that the received actual URL is a new URL or a URL which has been accessed in the past.

When the received actual URL has been accessed in the past as a result of determination, in block 960, the shortened URL managing device transmits the result to a processor of the user terminal 430 to display a predetermined color indicating that the actual URL has been accessed in the past on the display to notify the user. Continuously, in block 980, the shortened URL managing device 800 stores the shortened URL corresponding to the actual URL in the URL database to recognize that the URL is a URL which has been accessed in a succeeding process.

When the received actual URL is a new URL which has not been accessed as a determination result of block 950, in block 970, the shortened URL managing device notifies the fact to the user through the user terminal 430. The above-mentioned method may include a method which implements a predetermined color on the display as described in the above, but is not limited thereto.

In block 990, the received shortened URL and the actual URL are new URLs which have not been accessed in the past and are converted into the accessed URL by selection of the user so that the URLs are stored in the URL database to recognize that the URL has been accessed in the past in the succeeding process. For example, the shortened URL managing device 800 may store the shortened URL together with the browsing history in the shortened URL list 510 of the URL database and store the actual URL together with the browsing history in the actual URL list 515. According to some embodiments, the shortened URL managing device 800 may store the shortened URL and the actual URL in the combined URL list of the URL database together with the browsing history.

The present invention may be implemented as a recording medium including a command which is executed by a computer such as a program module which is executed by the computer. The computer readable medium may be an arbitrary available medium which is accessible by a computer and includes all of volatile and non-volatile media, and removable and non-removable media. Further, the computer readable medium may include all of a computer storage medium and a communication medium. The computer storage medium includes all of volatile and non-volatile media, and removable and non-removable media which are implemented by an arbitrary method or technique for storing information such as a computer readable command, a data structure, a program module, and other data. A communication medium typically includes a computer readable command, a data structure, a program module, or other data or a modified data signal such as a carrier wave or other transmitting mechanism and also includes an arbitrary information transfer medium.

The above-description of the present invention is illustrative only and it is understood by those skilled in the art that the present invention may be easily modified to another specific type without changing the technical spirit of an essential feature of the present invention. Thus, it is to be appreciated that the embodiments described above are intended to be illustrative in every sense, and not restrictive. For example, a component which is described as a singular form may be embodied to be dispersed or components which are dispersed may be embodied to be a combined form.

The scope of the present invention is represented by the claims to be described below rather than the detailed description, and it is to be interpreted that the meaning and scope of the claims and all the changes or modified forms derived from the equivalents thereof come within the scope of the present invention.

1. A method which is performed in a communication apparatus, the method comprising:
receiving a shortened uniform resource location (URL) from a server through a network;
comparing the shortened URL with at least one URL in a URL database to obtain a first result value;
receiving an actual URL corresponding to the shortened URL from a shortened URL providing server through the network; and
comparing the actual URL with at least one URL in the URL database to obtain a second result value.

2. The method of claim 1, further comprising:
before the receiving of an actual URL,
requesting an actual URL corresponding to the shortened URL to the shortened URL providing server.

3. The method of claim 1, further comprising:
notifying that a user of the communication apparatus accesses the web page of the shortened URL to the user of the communication apparatus when the first result value indicates that the shortened URL is included in the URL database.

4. The method of claim 3, wherein the notifying is performed based on a predetermined color on a display of the communication apparatus.

5. The method of claim 1, further comprising:
storing the shortened URL in the URL database when the first result value indicates that the shortened URL is not included in the URL database.

6. The method of claim 1, further comprising:
notifying that a user of the communication apparatus accesses the web page of the actual URL to the user of the communication apparatus when the second result value indicates that the actual URL is included in the URL database.

7. The method of claim 6, wherein the notifying is performed based on a predetermined color on a display of the communication apparatus.

8. The method of claim 1, further comprising:
storing the actual URL in the URL database when the second result value indicates that the actual URL is not included in the URL database.

9. The method of claim 1, wherein the URL database is stored in a storage device of the communication apparatus.

10. The method of claim 1, wherein the URL database is stored in a second server which is connected through the network.

11. The method of claim 9, wherein the URL database includes at least one URL and at least one of browsing histories each of the URL.

12. A shortened URL managing device which is used in a communication apparatus, the device comprising:
a shortened URL receiving module which receives a shortened URL from a server through a network;
an actual URL receiving module which receives an actual URL corresponding to the shortened URL from a shortened URL providing server through the network; and
a URL comparing module which compares the actual URL with at least one URL in a URL database.

13. The device of claim 12, wherein the URL comparing module further compares the shortened URL with at least one URL of the URL database.

14. The device of claim 13, wherein in the shortened URL managing device, as a result of comparing the shortened URL with at least one URL in the URL database, when the shortened URL is not included in the URL database, the actual URL receiving module further requests an actual URL corresponding to the shortened URL to the shortened URL providing server.

15. The device of claim 12, further comprising:
a comparison result transmitting module which outputs a comparison result value of the URL comparing module.

16. The device of claim 15, wherein in the shortened URL managing device, as a result of comparing the shortened URL with at least one URL in the URL database, when the shortened URL is included in the URL database, the comparison result transmitting module outputs a result value indicating that the user of the communication apparatus has accessed the web page of the shortened URL.

17. The device of claim 16, wherein the communication apparatus includes a display and the result value is implemented based on a predetermined color on the display.

18. The device of claim 15, wherein in the shortened URL managing device, as a result of comparing the actual URL with at least one URL in the URL database, when the actual URL is included in the URL database, the comparison result transmitting module outputs a result value indicating that the user of the communication apparatus has accessed the web page of the actual URL.

19. The device of claim 18, wherein the communication apparatus includes a display and the result value is implemented based on a predetermined color on the display.

20-22. (canceled)

23. A recording medium in which a computer program which is executed on a processor of electronic equipment having a communication function is recorded, wherein the computer program causes the processor to perform:
receiving a shortened URL from a server through a network;
comparing the shortened URL with at least one URL in a URL database to obtain a first result value;
requesting an actual URL corresponding to the shortened URL to a shortened URL providing server through the network;
receiving an actual URL corresponding to the shortened URL from the shortened URL providing server through the network; and
comparing the actual URL with at least one URL in the URL database to obtain a second result value.

24-29. (canceled)
